(19) United States
(12) Patent Application Publication
(10) Pub. No.: US 2024/0220848 A1
(43) Pub. Date: Jul. 4, 2024

(54) SYSTEMS AND METHODS FOR TRAINING VIDEO OBJECT DETECTION MACHINE LEARNING MODEL WITH TEACHER AND STUDENT FRAMEWORK

(71) Applicant: Robert Bosch GmbH, Stuttgart (DE)

(72) Inventors: Tanvir MAHMUD, Austin, TX (US); Chun-Hao LIU, Fremont, CA (US); Burhaneddin YAMAN, San Jose, CA (US)

(21) Appl. No.: 18/090,635

(22) Filed: Dec. 29, 2022

(51) Int. Cl. G06N 20/00

(52) U.S. Cl. CPC G06N 20/00

(57) ABSTRACT

Systems and methods for training an object-detection machine learning model with teacher and student framework. The training is intended to exploit a large number of unlabeled image or video frames with few labeled image or video frames for semi-supervised video object detection. For example, the object-detection machine learning model can be pre-trained based on labeled video data, and utilizing pre-trained weights, which initializes a teacher model and a student model with the pre-trained weights. The teacher model is trained to generate pseudo-labels for the unlabeled video data. The student model is trained to generated predicted pseudo-labels for the unlabeled video data, wherein the training of the student model is based on (i) the labeled video data and (ii) the pseudo-labels associated with the unlabeled video data.

### TECHNICAL FIELD

The present disclosure relates to systems and methods for training an object detection machine learning model with a teacher and student framework.

### BACKGROUND

Image object classification generally relates to processing an image (e.g. a static image) to determine the presence and location of one or more salient (e.g. common) objects, and outputting a mask or bounding box that identifying the pixels in the image where each object is located. The pixels representing the detected object can also be classified (e.g., person, animal, vehicle) based on object recognition techniques. Video object classification is similar, however a video is a sequence of frames over a period of time where each frame defines an image and where the object's location in different frames may be different. For example, a video may commence with an initial frame and progress to a subsequent frames in an ordered sequence. A video clip may be a whole video or a portion of one, commencing from an initial frame—e.g. a reference frame—to subsequent frames until the end of the clip. Objects that appear in the reference frame may move locations from one frame to another, for example, because the object is in motion relative to the camera, the camera is in motion relative to the object, or both the camera and object are moving. Also, while the object moves from frame to frame, the reliability or certainty of the classification of that object may vary. Accurate and reliable tracking and classifying of objects through a video clip is desirable for many reasons. For example, in the context of autonomous vehicles, the location of a pedestrian may be important for maneuvering (e.g., braking, steering) the vehicle for collision avoidance. Detecting and tracking objects may have other purposes, too.

Detecting, classifying, and tracking objects through a video is challenging for computing devices. Image processing techniques to identify and classify objects in a single static image are well-known using various network models trained using supervised learning techniques. However, identifying and classifying an object from one image to the next image in a video can pose problems. The known networks are not properly trained for such tasks. One issue is that appropriate training data for supervised learning is not widely available.

### SUMMARY

According to an embodiment, a method of training an object-detection machine learning model is provided. The method includes receiving video data derived from one or more cameras; extracting labeled video data and unlabeled video data from the video data, wherein the labeled video data includes labels corresponding to one or more detected objects in the video data; pre-training an object-detection machine learning model based on the labeled video data, wherein the pre-training utilizes pre-trained weights, and wherein the pre-training initializes both a teacher model and a student model with the pre-trained weights; training the teacher model to generate pseudo-labels for the unlabeled video data, wherein the training of the teacher model is based on the unlabeled video data, wherein the teacher model utilizes teacher weights initialized based on the pre-trained weights; training the student model to generate predicted labels for the unlabeled video data, wherein the training of the student model is based on (i) the labeled video data and (ii) the pseudo-labels associated with the unlabeled video data, wherein the student model utilizes student weights initialized based on the pre-trained weights, wherein iterations of the training of the student model updates the student weights; updating the student weights based on the predicted labels and pseudo-labels; updating the teacher weights based on the student weights; and repeating the steps of training the teacher model, training the student model, and updating the student and teacher weights until convergence with both the teacher weights and student weights.

According to an embodiment, a system for training an object-detection machine learning model includes a processor and memory having instructions stored thereon that, when executed by the processor, cause the processor to perform the following: receive video data derived from one or more cameras; extract labeled video data and unlabeled video data from the video data, wherein the labeled video data includes labels corresponding to one or more detected objects in the video data; pre-train an object-detection machine learning model based on the labeled video data, wherein the pre-training utilizes pre-trained weights, and wherein the pre-training initializes both a teacher model and a student model with the pre-trained weights; train the teacher model to generate pseudo-labels for the unlabeled video data, wherein the training of the teacher model is based on the unlabeled video data, wherein the teacher model utilizes teacher weights initialized based on the pre-trained weights; train the student model to generate predicted labels for the unlabeled video data, wherein the training of the student model is based on (i) the labeled video data and (ii) the pseudo-labels associated with the unlabeled video data, wherein the student model utilizes student weights initialized based on the pre-trained weights, wherein iterations of the training of the student model updates the student weights; update the student weights based on the predicted labels and pseudo-labels; update the teacher weights based on the student weights; and repeat the training of the teacher model, the training of the student model, and the updating of the student and teacher weights until convergence with both the teacher weights and student weights.

According to an embodiment, a method of training an object-detection machine learning model includes: receiving video data derived from one or more cameras; extracting labeled video data and unlabeled video data from the video data, wherein the labeled video data includes labels corresponding to one or more detected objects in the video data; pre-training an object-detection machine learning model based on the labeled video data, wherein the pre-training utilizes pre-trained weights, and wherein the pre-training initializes both a teacher model and a student model with the pre-trained weights; and doing the following until convergence: training the teacher model to generate pseudo-labels for the unlabeled video data, wherein the training of the teacher model is based on the unlabeled video data, wherein the teacher model utilizes teacher weights initialized based on the pre-trained weights; and training the student model to generate predicted labels for the unlabeled video data, wherein the training of the student model is based on (i) the labeled video data and (ii) the pseudo-labels associated with the unlabeled video data, wherein the student model utilizes student weights initialized based on the pre-trained weights, wherein iterations of the training of the student model updates the student weights.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 shows the framework of an object-detection machine learning model, according to an embodiment.

FIG. 4 is a flowchart of a method for training the object-detection machine learning model, according to an embodiment.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Scarcity of the annotated samples is one of the most challenging problems in deep learning, particularly for object detection requiring class and bounding box annotations for each instance. Detecting, classifying, and tracking objects through a video is challenging for computing devices, for reasons explained above. For object classification and tracking in images, and particularly in video, much of the data is unlabeled and unannotated. Video data comes with sequential image frames that contains both temporal and spatial information. However, annotating all the available frames of videos is costly and time consuming, and often contains redundant information for significant feature correlation of subsequent frames. Existing approaches mostly rely on static image detectors and primarily focus on post-processing detected bounding boxes, referred to as box-level methods. However, state-of-the-art video object detectors mainly operate on the feature space to aggregate motion cues since heuristic post-processing techniques can be easily integrated. Levering semi-supervised learning with these detectors demands a bottom-up approach to generate high-quality pseudo-labels.

Semi-supervised learning is a promising direction to utilize the unlabeled samples with some labeled samples, and thus it is widely explored in several applications. Despite significant research effort on semi-supervised object detection on images, such techniques are left unexplored in case of video object detection. One straightforward solution could be considering the frames of videos as static images leaving the temporal information to utilize the existing framework. However, such an approach provides sub-optimal performance as it does not utilize the temporal information. Current existing solutions deals with only supervised video object detection. Therefore, developing a robust semi-supervised video object detection solution to exploit both temporal and spatial information remains critical.

Therefore, this disclosure proposes a semi-supervised video object detection (SSVD) solution to achieve comparable performance with a fraction of labeled data. This disclosure provides systems and methods to exploit large numbers of unlabeled frames with few labeled frames for semi-supervised video object detection. The disclosed methods and systems greatly increase the data-efficiency of video object detection. Embodiments of the methods and systems disclosed herein utilize a teacher-student training framework in image (e.g., video) object detection to generate robust pseudo-labels for the unlabeled frames utilizing the motion features of surrounding frames, robust proposal-filtering, and class-uncertainty aware pseudo-label filtering.

An object of the present disclosure can be defined as follows. Given a total N collected frames of the videos, only K of them contain annotations (e.g., class labels, bounding boxes). An object of this disclosure is to develop a video object detection training framework that can exploit the N−K unlabeled frames in the training pipeline to achieve similar performance as a supervised training which adopts label numbers much larger than K.

This disclosure introduces a teacher-student based semi-supervised video object detection training framework that can exploit both labeled and unlabeled frames. Initially, a labeled dataset and unlabeled dataset are defined and extracted from the available video frames. Both the labeled and unlabeled datasets contains a key video frame at time stamp/and several nearby or adjacent reference video frames that has been taken from the temporal window of [t−k, t+k]. On each set of key and reference frames, the model detects the objects in the key frames and the reference frames are used to strengthen the key frame features.

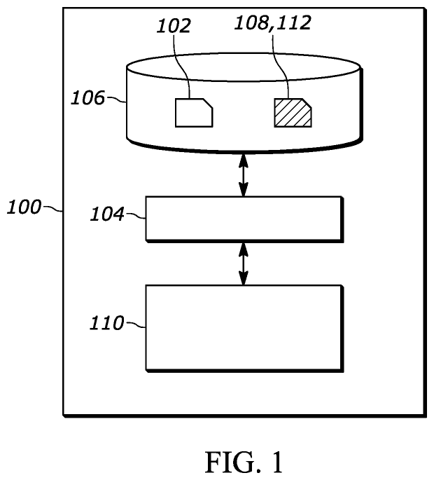

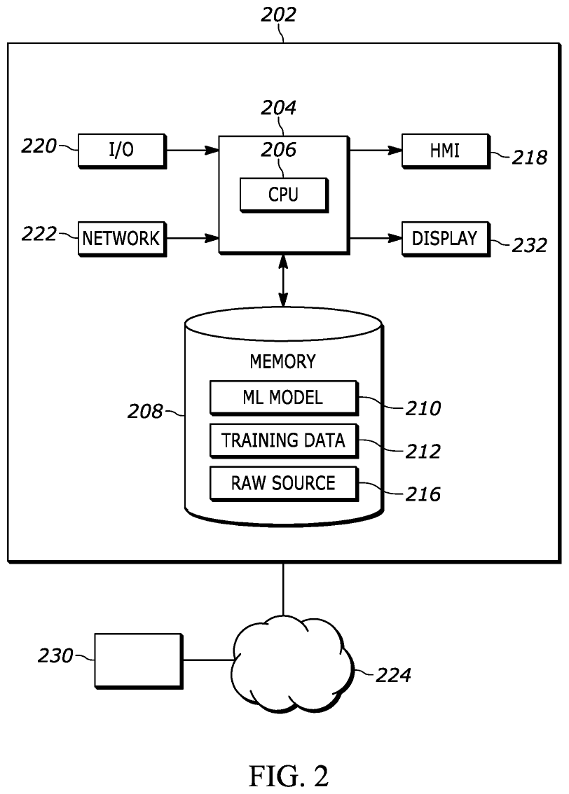

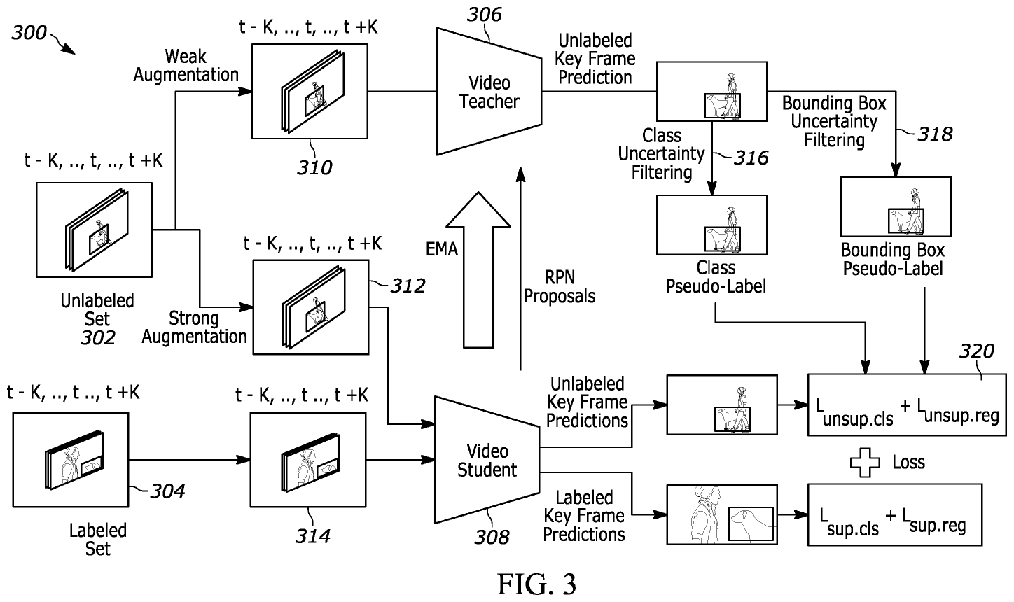

Before providing additional details on the disclosed video object detection framework (exemplified in FIG. 3), a general framework of training machine learning models should be described. This is illustrated in FIGS. 1-2, in which FIG. 1 shows a system 100 for training a machine learning model (e.g., neural network, a deep neural network, etc.), and FIG. 2 shows a computer-implemented method for training and utilizing a neural network. Referring to FIG. 1, the system 100 may comprise an input interface for accessing training data 102 for the neural network. For example, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The structure of the system 100 is one example of a system that may be utilized to train the machine learning models described herein (e.g., object-detection machine learning model, student model, teacher model, etc.). Additional structure for operating and training the machine-learning models is shown in FIG. 2.

FIG. 2 depicts a system 200 to implement the machine-learning models described herein, for example the object-detection machine learning model, student model, teacher model described herein. The system 200 can be implemented to perform object detection and classification processes described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm (such as the object-detection machine learning model, student model, and teacher model), a training dataset 212 for the machine-learning models 210, and raw source dataset 216 (e.g., image data, video data, etc.).

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

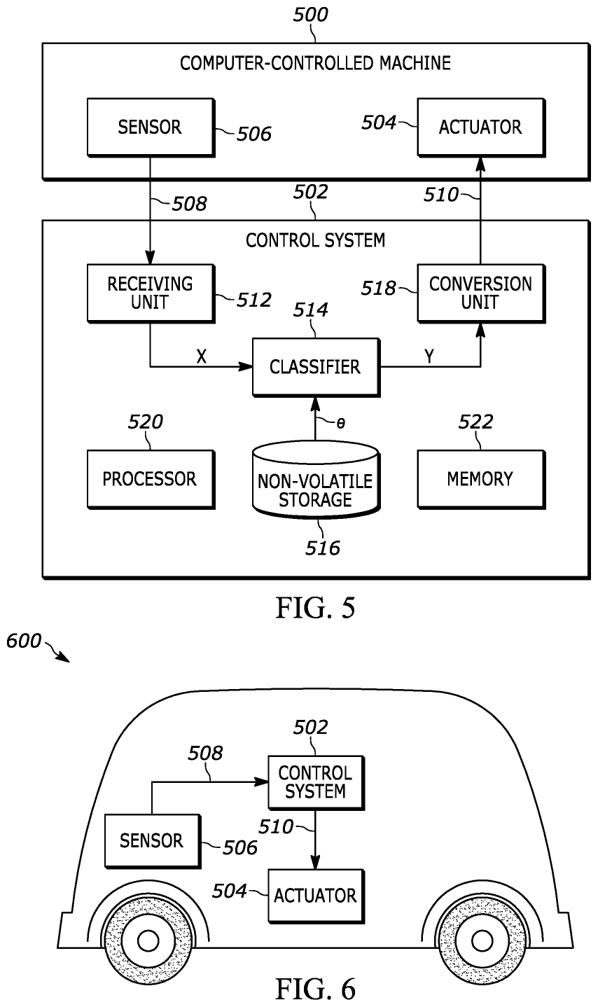

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time, images over time, etc.), and raw or partially processed sensor data (e.g., radar map of objects). Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate the object-detection machine learning model, student model, and teacher model described herein.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a pedestrian). The input images may include various scenarios in which the objects are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a pedestrian in video images and annotate the occurrences to label the associated data. The machine-learning algorithm 210 may be programmed to process the raw source data 216 to identify the presence of the particular features. The machine-learning algorithm 210 may be configured to identify a feature in the raw source data 216 as a predetermined feature (e.g., pedestrian, road sign). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In an example, the raw source data 216 may include image data representing an image. Applying the machine-learning algorithms described herein, the output can be a trained object-detection machine learning model configured to label unlabeled image/video data.

Using the above description of the machine-learning models, along with the structural examples of FIGS. 1-2 configured to carry out the models, FIG. 3 illustrates a system 300 or framework for training an object-detection machine learning model. This framework can also be referred to as a semi-supervised video object detection (SSVD) model. This training framework will improve the object-detection machine learning model's output of labeling unlabeled video data. While video data is described as being used in the system 300, of course it should be understood that the scope of the invention is not necessarily limited as such. For example, the teachings of this disclosure can be applied to image data (e.g., still images), radar data, sound data, and the like as described above.

Supervised video object detection primarily focuses on aggregating surrounding context from nearby frames to enhance detection of a particular frame. Thus, there are two type of frames, namely key and reference frames, considered in video detection. Key frames are annotated for detection from sparse regions, and reference frames surrounding the key frames are used for feature enhancement. To train on different time steps of the video, a large number of key frames are usually required throughout the video. For example, consider dataset D consisting M videos where D={V¹, V², . . . , V^{M}}. Each training video contains N frames with nₖ annotated key frames and nᵣ reference frames, such that nₖ+nᵣ=N. The supervised training objective for a video object detection network Z_{θ} parameterized by θ can be expressed as

$${argmin}_{θ} {\sum }_{m = 1}^{M} {\sum }_{t = 1}^{{n}_{k}} ℒ ( {Z}_{θ} ( {R}_{m}^{t - i} , {K}_{m}^{t} , {R}_{m}^{t + i} ) ; {y}_{m}^{t} )$$

where L is a pre-defined loss function, Kₘ^{t}, yₘ^{t} denote the t^{th} key frame and corresponding annotation in m^{th} video, respectively, and Rₘ^{t-i}, Rₘ^{t+i} represent the reference frame at time t−i and t+i, respectively. The supervised training objective is limited by the availability of the annotated key frames. Though annotations for the reference frames are not required, the nearby reference frames are used for proper feature enhancement. With a limited number of labeled key frames on a particular video, the majority of the frames from other time-steps will remain unused in the supervised setting.

Instead of only relying on labeled key frames, the semi-supervised approach targets robust pseudo-label generation for unlabeled key frames throughout the video. Therefore, training can be continued on different time-steps of the video utilizing the labeled and pseudo-labeled key frames. Given that each video contains nₖ^{u} unlabeled key frames and nₖ^{l} labeled key frames such that nₖ^{l}+nₖ^{u}=nₖ, the semi-supervised objective disclosed herein can be defined as follows:

$${argmin}_{θ} ( \text{} {\sum }_{m = 1}^{M} {\sum }_{t = 1}^{{n}_{k}^{l}} ℒ ( {Z}_{θ} ( {R}_{m}^{t - i} , {K}_{m}^{t} , {R}_{m}^{t + i} ) ; {y}_{m}^{t} ) + {\sum }_{m = 1}^{M} {\sum }_{t = 1}^{{n}_{k}^{u}} ℒ ( {Z}_{θ} ( {R}_{m}^{t - i} , {K}_{m}^{t} , {R}_{m}^{t + i} ) ; {p}_{m}^{t} ) ) ,$$

where pₘ^{t} denotes the pseudo-label generated for the t^{th} unlabeled key frame from the m^{th} video. As video contains high feature correlations across frames, this approach can generate robust pseudo-labels relying on much fewer annotations. Therefore, the proposed semi-supervised formulation ensures utilization of sufficient key-reference pairs across the video without being entirely limited by human annotations.

The accuracy of estimated pseudo-labels bears great importance for the performance of the semi-supervised formulation of video object detection. To this end, the proposed semi-supervised video object detection (SSVD) framework disclosed herein can generate robust pseudo-labels and relies on limited annotations of key frames. SSVD utilizes a teacher-student framework. The student network is trained with both labeled and unlabeled data while the teacher network is derived by exponential moving average (EMA) of the weights from the student network. The teacher network generates pseudo-labels for the unlabeled key frames and guides the student network. The disclosed SSVD is detector agnostic, e.g., it can incorporate any state-of-the-art two-stage video object detector for both the teacher and student networks. Each of the networks takes a set of images as inputs where each set contains one key frame and several surrounding reference frames to strength key features. A goal is to generate correct predictions for key frames by aggregating the reference features on key features. The similar weak/strong augmentations are applied on all of the images of the unlabeled set. The teacher operates on the weakly-augmented unlabeled sets to generate pseudo labels while the student operates on both labeled and strongly augmented unlabeled sets.

Referring to FIG. 3 in particular, according to embodiments herein with a semi-supervised video object detection model, video data is received by the system 300. The video data may be raw data as explained above, and can include both unlabeled video data 302 and labeled video data 304. The unlabeled video data 302 and labeled video data 304 can be extracted from one or more video feeds or larger packets of video data. The labeled video data includes labels corresponding to one or more detected objects in the video data. For example, the labeled video data 304 may include a bounding box, mask, or the like with an associated label that indicates the classification of the detected object (e.g., pedestrian, vehicle, animal, building, road sign, bar code, etc.). In contrast, the unlabeled video data 302 may not include any classification information associated with an object in the image.

In embodiments, the labeled video data and the unlabeled video data each contain respective key video frames at time stamp t and several nearby or adjacent reference video frames that has been taken from the temporal window of [t−k, t+k], where k is the temporal value different than t in which the adjacent frames are between t and k. The number of adjacent frames in the temporal window can be one, or more than one. In one example, the number of adjacent frames is between 2 and 20. The key frame can be determined manually (e.g., by human), or can be automatically selected based on certain qualities of the frame, for example blurry objects, or frames that are hard to decipher, process or understand. On each set of key and reference frames, the model detects the objects in the key frames and the reference frames are used to strengthen the key frame features.

First, a process of supervised pre-training and teacher-student initialization takes place. Initially, while not shown in FIG. 3, the object-detection machine learning model is trained on the supervised sets of key and reference frames of both the labeled and unlabeled video data. The model is pre-trained with an attempt to output a label for an unlabeled video frame, based on the knowledge gleaned from the frames that are already labeled.

Once the object-detection model is pre-trained with the image data during a first phase of training, a teacher machine learning model 306 (referred to herein as a teacher model or a video teacher) and a student machine learning model 308 (referred to herein as a student model or a video student) are both initialized with pre-trained weights to initiate a second phase of training of the object-detection machine learning model. The pre-trained weights can initially be the same weights that were used in the pre-training of the object-detection machine learning model. The teacher and student models are initiated to start learning on unlabeled video data.

The teacher and student models can be initialized to initiate semi-supervised teacher-student model training. In this phase, both the labeled video data and the unlabeled video data are used to jointly train the teacher-student framework. Details of this training phase are illustrated in FIG. 3. A primary task of the teacher model 306 is to generate pseudo-labels for the unlabeled video data that will be used to train the student model to label the unlabeled video data. In short, the teacher model 306 is provided with the unlabeled video data that is not augmented (which will be described later). In other words, at least a portion of the unlabeled video data 302 is input into the teacher model 306. Meanwhile, the student model 308 is continuously trained, and its weights updated, based on strongly-augmented unlabeled video data, and weakly-augmented labeled video data. The teacher model can be trained, and its weights updated, based on the output of the student model. Various parts of this training are described further below.

The system 300 may include a data split and weak-strong augmentation process. In this process, the teacher model 306 receives only the unlabeled video data (e.g., shown at 310) to generate pseudo-labels, while the student model 308 receives both labeled video data and unlabeled video data. To make the teacher model more confident (e.g., improve its accuracy) regarding its generated pseudo-labels, the teacher model 306 receives weakly-augmented key frames and weakly-augmented reference frames of the unlabeled video data. For example, a weak augmentation of a key frame may be a slight change to the pixels such as a change in color, a change in the contrast, blurriness, or the like. In contrast, the student model receives strongly-augmented unlabeled video data (e.g., shown at 312) to make it more resilient across perturbations of the unlabeled video data. Examples of a strong augmentation to the image data includes flipping the orientation of the image or objects therein, resizing or re-orienting objects, color distribution, bounding box jittering, image cropping, image rotation, image translation, and the like, or other distortions that are stronger than the weak augmentations. As the object-detection machine learning model is already pre-trained on the labeled sets during the supervised pre-training as explained above, weak augmentations are applied on the labeled video data at 314, which is input only into the student model 308—not the teacher model 306. Same or similar augmentation parameters are carefully maintained for the key frames and reference frames in all of the labeled video data and unlabeled video data to perform appropriate feature aggregations from the reference frames to the key frames.

The training of the student and teacher models can be summarized as follows, according to an embodiment. Initially, the object-detection machine learning model is pre-trained on the image (e.g., video) data, and then on available supervised video data. The object-detection machine learning model is pre-trained with pre-trained weights. Then, the teacher model and student model are initiated with the same pre-trained weights as the object-detection machine learning model in order to start learning on unlabeled video data (e.g., to predict a classification of an object in the unlabeled video data). The teacher generates pseudo-labels for the unlabeled video data, but is not trained in a traditional way. Instead, the teacher model is updated after an interval by taking an average (e.g., weighted average) of its current weight and the student model's current weight. But, the student model is continuously updated and trained on both the labeled video data and unlabeled video data. The annotations or labels for the labeled supervised data is provided, and the teacher model generates pseudo-labels for the unlabeled video data. These labels and pseudo-labels are used to train the student model.

The system 300 may also utilize a region proposal network (RPN) to generate proposed augmentations, such as bounding boxes. A two-stage training framework can be used in which the system 300 generates proposals of bounding boxes in the first phase. Later, the objects are detected by analyzing the region-of-interests of the proposal regions (e.g., the areas inside the bounding boxes). Despite maintaining separate teacher and student models, it is expected that in some cases the student model 308 can be more certain regarding its augmentation, labeling or classifying some objects than the teacher model 306. To assist the teacher for better exploration of the region-of-interests, the student will share the high-confident bounding boxes with the teacher. Hence, the teacher will augment the proposal regions by merging the student's proposals. This is shown in FIG. 3 as RPN Proposals.

As the pseudo-labels are directly used to train the student model, filtering can be introduced to assure uncertain pseudo-labels are removed from the process. Therefore, the system 300 may also use class-uncertainty aware filtering of predicted pseudo-labels, shown generally at 316. To increase the robustness or accuracy of the predicted pseudo-labels regarding the classification of the detected object, the system can utilize two-stage filtering on the generated pseudo-labels output by the teacher model 306. Initially, confidence thresholding is carried out to isolate the low-confident predictions of pseudo-label. For example, a confidence threshold may be set, and any predicted object classification with an associated confidence score below that threshold may be removed. Subsequently, the class uncertainty is evaluated by measuring the entropy of the class predictions for each bounding box. The bounding box with high uncertainty (e.g., below the confidence threshold or a separate uncertainty threshold) is removed from the training pipeline. In an embodiment, the class uncertainty U is estimated by:

$${U}_{cls}^{p} = {\sum }_{i = 1}^{C} - {X}_{i} log ( {X}_{i} )$$

where X is a prediction probability of C classes.

The system 300 may also use bounding box uncertainty filtering, shown generally at 318. The generated bounding boxes can be more prone to false predictions. Therefore, it may be beneficial to more properly estimate the uncertainty. Using image-based object detection techniques (e.g., SoftTeacher, cited upon filing this disclosure and incorporated by reference in its entirety), group box-jittering can be incorporated to measure the bounding box uncertainty. Initially, the bounding boxes are filtered from the pseudo-labels using the confidence thresholding, similar to that described above. Subsequently, some random jitters are added to the predicted pseudo-label bounding boxes of the key frames, as well as to the high confidence reference frame proposals. Then, the jittered bounding boxes of pseudo-labels and high-confident reference frame proposals are passed through another phase of processing with teacher's detection head. Afterwards, the standard deviations of the four edges of each bounding box are measured that identifies the robustness of the predicted bounding boxes. Finally, the mean variation of four edges is considered as the uncertainty measurement of the bounding boxes. This can be represented by:

$$[ {σ}_{x} , {σ}_{y} , {σ}_{w} , {σ}_{h} ] = σ ( ROI Head ( Jitter ( {P}_{ref} ) , Jitter ( {P}_{key} ) ) )$$

$${σ}_{mean} = \frac{1}{4} \sum ( {σ}_{x} , {σ}_{y} , {σ}_{w} , {σ}_{h} )$$

where σ represents the standard deviation for each of the four edges x, y, w, h of the bounding boxes.

The student model 308 can be updated with any predefined optimizers leveraging gradient descent techniques, and the teacher model 306 can be updated with the exponential moving average (EMA) of the student's weight after each training epoch. The weights of the student model can be updated for various iterations, and for each iteration, the weights of the teacher model can be updated based on an average of the current (last) weight of the teacher model and the current (last) weight of the student model.

During the training, over the multiple iterations, losses are computed between the pseudo-labels generated by the teacher model, and those predicted by the student model. As shown in the example of FIG. 3, the class uncertainty filtering can yield a generated class pseudo-label, and the bounding box uncertainty filtering can yield a bounding box pseudo-label. Those generated pseudo-labels can be compared to the predicted pseudo-labels output by the student model 308. The process continues until convergence, e.g., an agreement between the predicted pseudo-labels and the generated pseudo-labels. Once convergence is reached, a trained object-detection machine learning model is provided. This trained object-detection machine learning model is configured to generate labels (e.g., bounding boxes, classes, etc.) of unlabeled data even though a relatively small amount of labeled data is provided.

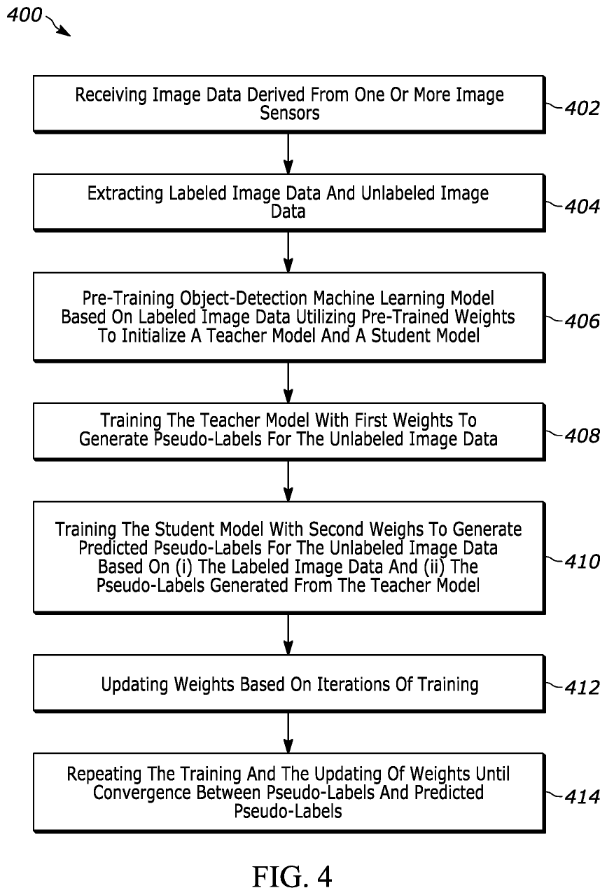

FIG. 4 illustrates an exemplary method 400 of training an object-detection machine learning model such as the one disclosed herein. The processor, memory, and other computer structure of FIGS. 1-2 can be utilized to perform this method. At 402, the processor receives image data derived from one or more image sensors, such as a camera or the like. The image data may be associated with images captured from a camera, for example, and may include other data such as labels or pseudo-labels, distortions, and the like as disclosed herein.

At 404, labeled image data and unlabeled image data is extracted from the image data received at 402. The labeled video data includes labels corresponding to one or more detected objects in the video data.

At 406, the processor performs a step of pre-training an object-detection machine learning model based on the labeled image data utilizing pre-trained weights. The pre-training initializes both a teacher model and a student model with the pre-trained weights.

At 408, the processor performs a step of training the teacher model with first weights (e.g., teacher weights) to generate pseudo-labels for the unlabeled image data. The training of the teacher model is based on the unlabeled image data, and utilizes the teacher weights initialized based on the pre-trained weights.

At 410, the processor performs a step of training the student model with second weights (e.g., student weights) to generate predicted labels for the unlabeled video data. The training of the student model is based on (i) the labeled video data and (ii) the pseudo-labels associated with the unlabeled video data. The student model utilizes student weights initialized based on the pre-trained weights, and iterations of the training of the student model updates the student weights.

At 412, the weights of both the student model and the teacher model are updated based on the results of a training iteration. Then, at 414, the steps of training and updating of the weights is repeated until convergence between the weights of the teacher model and of the student model.

The training of the machine learning models—and ultimate use of the trained machine-learning models—described herein can be used in many different applications. Examples of such applications are shown in FIGS. 6-11. The underlying computerized structure used for training and implementing the machine-learning models for these applications (and other applications) are exemplified in FIG. 5. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video (e.g., camera), radar, LiDAR, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine-learning algorithm, such as a neural network described above. Classifier 514 may include the trained object-detection machine learning model described above, being trained to label (e.g., classify) unlabeled image or video data. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above with regard to pre-trained classifier 306) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more machine-learning algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 520, the computer-executable instructions of non-volatile storage 516 may cause control system 502 to implement one or more of the machine-learning algorithms and/or methodologies as disclosed herein. Non-volatile storage 516 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. In the context of object-recognition and processing as described herein, the sensor 506 can be a camera mounted to or integrated into the vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x, such as described with reference to FIGS. 3-4. In such an embodiment, output signal y may include information characterizing the vicinity of objects to vehicle 600. Actuator control command 510 may be determined in accordance with this information. The actuator control command 510 may be used to avoid collisions with the detected objects.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

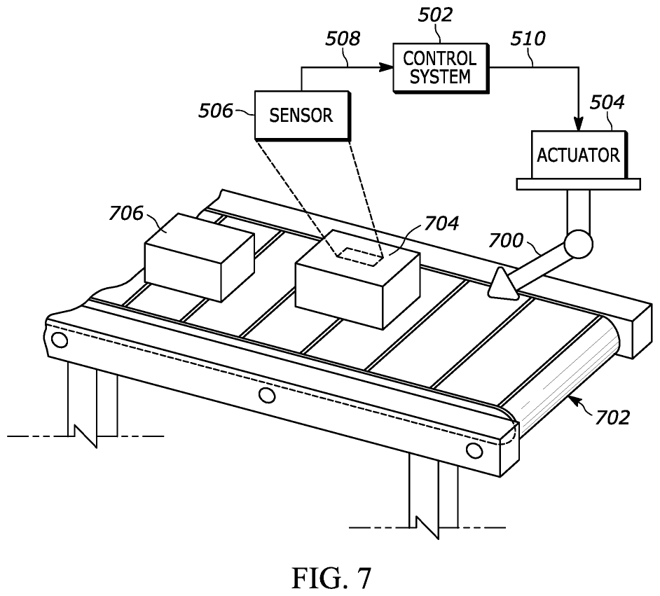

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

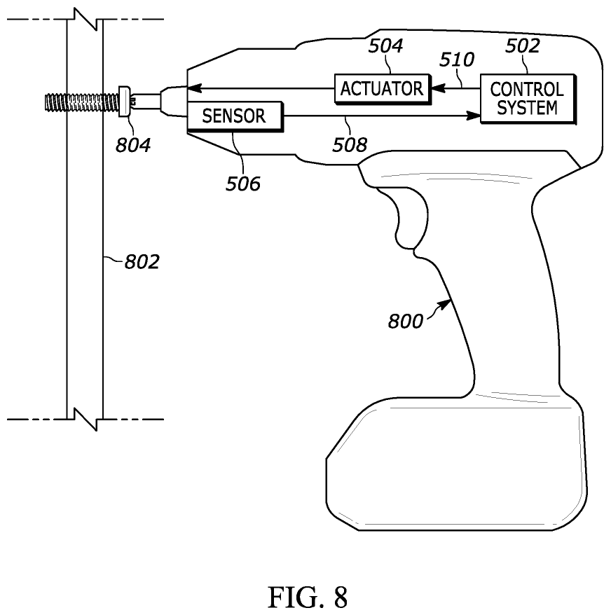

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

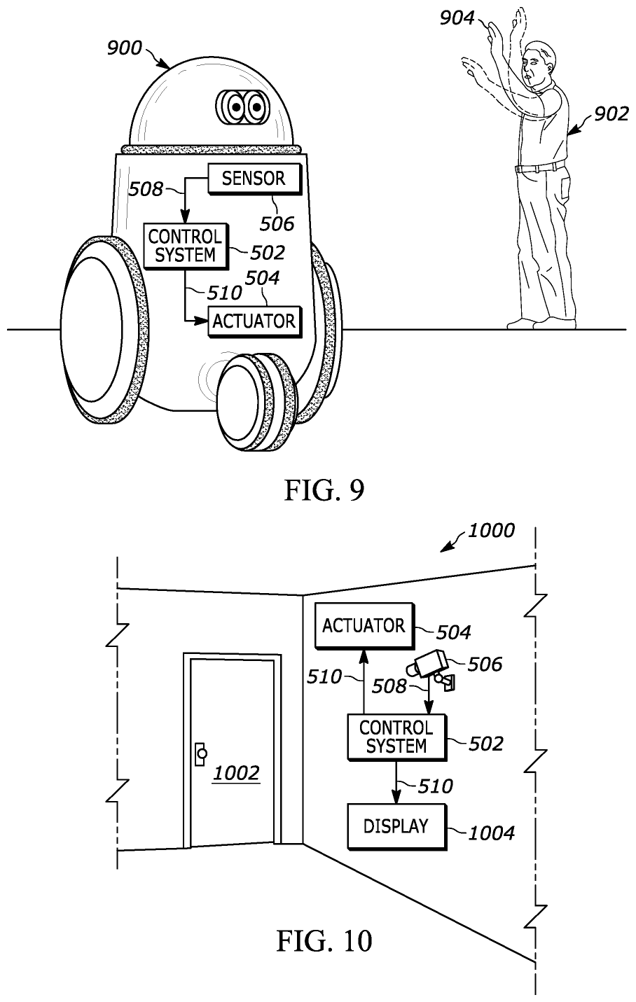

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

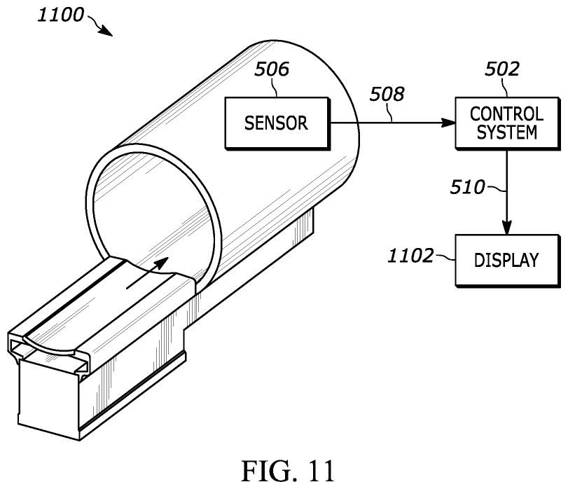

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of training an object-detection machine learning model, the method comprising:
receiving video data derived from one or more cameras;
extracting labeled video data and unlabeled video data from the video data, wherein the labeled video data includes labels corresponding to one or more detected objects in the video data;
pre-training an object-detection machine learning model based on the labeled video data, wherein the pre-training utilizes pre-trained weights, and wherein the pre-training initializes both a teacher model and a student model with the pre-trained weights;
training the teacher model to generate pseudo-labels for the unlabeled video data, wherein the training of the teacher model is based on the unlabeled video data, wherein the teacher model utilizes teacher weights initialized based on the pre-trained weights;
training the student model to generate predicted labels for the unlabeled video data, wherein the training of the student model is based on (i) the labeled video data and (ii) the pseudo-labels associated with the unlabeled video data, wherein the student model utilizes student weights initialized based on the pre-trained weights, wherein iterations of the training of the student model updates the student weights;
updating the student weights based on the predicted labels and pseudo-labels;
updating the teacher weights based on the student weights; and
repeating the steps of training the teacher model, training the student model, and updating the student and teacher weights until convergence with both the teacher weights and student weights.

2. The method of claim 1, wherein the convergence yields a trained object-detection machine learning model configured to label unlabeled video data.

3. The method of claim 1, wherein each of the labeled video data and the unlabeled video data respectively include a key frame and a plurality of reference frames adjacent the key frame.

4. The method of claim 3, further comprising:
providing weak augmentations to a first group of the key frames and reference frames of the unlabeled video data; and
utilizing the weak augmentations during the training of the teacher model to generate the pseudo-labels.

5. The method of claim 4, further comprising:
providing strong augmentations to the key frames and reference frames of the wherein the training of the student model includes:
in order to generate the predicted labels, receiving, at the student model, (i) a strongly-augmented one of the key frames of the unlabeled video data, and (ii) a strongly-augmented one of the reference frames of the unlabeled video data.

6. The method of claim 1, wherein the updating of the teacher weights is based on an exponential moving average of a current weight of the student model.

7. The method of claim 3, wherein the pseudo-labels include class information associated with a detected object in the video data, and bounding boxes about the detected objects.

8. The method of claim 7, further comprising:
filtering the pseudo-labels generated by the teacher model in order to increase an accuracy of the predicted labels generated by the student model.

9. The method of claim 8, wherein the filtering includes:
isolating some of the predicted labels having a confidence below a prediction threshold; and
removing one or more of the bounding boxes with a class uncertainty exceeding an uncertainty threshold.

10. The method of claim 9, wherein the class uncertainty of the bounding boxes is determined by:
$${U}_{cls}^{p} = {\sum }_{i = 1}^{C} - {X}_{i} log ( {X}_{i} )$$
wherein X is a prediction probability of C classes, and U is the class uncertainty.

11. The method of claim 9, further comprising:
adding random jitters to some of the bounding boxes associated with some of the key frames and some of the reference frames;
processing, by the teacher model, the bounding boxes having the random jitters during the training of the teacher model; and
estimating an uncertainty of the bounding boxes by measuring a difference between edges of the bounding boxes without the random jitters and edges of the bounding boxes with the random jitters.

12. A system for training an object-detection machine learning model, the system comprising:
a processor; and
memory having instructions stored thereon that, when executed by the processor, cause the processor to:
receive video data derived from one or more cameras;
extract labeled video data and unlabeled video data from the video data, wherein the labeled video data includes labels corresponding to one or more detected objects in the video data;
pre-train an object-detection machine learning model based on the labeled video data, wherein the pre-training utilizes pre-trained weights, and wherein the pre-training initializes both a teacher model and a student model with the pre-trained weights;
train the teacher model to generate pseudo-labels for the unlabeled video data, wherein the training of the teacher model is based on the unlabeled video data, wherein the teacher model utilizes teacher weights initialized based on the pre-trained weights;
train the student model to generate predicted labels for the unlabeled video data, wherein the training of the student model is based on (i) the labeled video data and (ii) the pseudo-labels associated with the unlabeled video data, wherein the student model utilizes student weights initialized based on the pre-trained weights, wherein iterations of the training of the student model updates the student weights;
update the student weights based on the predicted labels and pseudo-labels;
update the teacher weights based on the student weights; and
repeat the training of the teacher model, the training of the student model, and the updating of the student and teacher weights until convergence with both the teacher weights and student weights.

13. The system of claim 12, wherein the convergence yields a trained object-detection machine learning model configured to label unlabeled video data.

14. The system of claim 12, wherein each of the labeled video data and the unlabeled video data respectively include a key frame and a plurality of reference frames adjacent the key frame.

15. The system of claim 14, wherein the instructions further cause the processor to:
provide weak augmentations to a first group of the key frames and reference frames of the unlabeled video data; and
utilize the weak augmentations during the training of the teacher model to generate the pseudo-label.

16. The system of claim 15, wherein the instructions further cause the processor to:
provide strong augmentations to the key frames and reference frames of the wherein the training of the student model includes:
in order to generate the predicted labels, receive, at the student model, (i) a strongly-augmented one of the key frames of the unlabeled video data, and (ii) a strongly-augmented one of the reference frames of the unlabeled video data.

17. The system of claim 12, the updating of the teacher weights is based on an exponential moving average of the current weight of the student model.

18. The system of claim 12, wherein the pseudo-labels include class information associated with a detected object in the video data, and bounding boxes about the detected objects.

19. A method of training an object-detection machine learning model, the method comprising:
receiving video data derived from one or more cameras;
extracting labeled video data and unlabeled video data from the video data, wherein the labeled video data includes labels corresponding to one or more detected objects in the video data;
pre-training an object-detection machine learning model based on the labeled video data, wherein the pre-training utilizes pre-trained weights, and wherein the pre-training initializes both a teacher model and a student model with the pre-trained weights; and
until convergence:
training the teacher model to generate pseudo-labels for the unlabeled video data, wherein the training of the teacher model is based on the unlabeled video data, wherein the teacher model utilizes teacher weights initialized based on the pre-trained weights, and
training the student model to generate predicted labels for the unlabeled video data, wherein the training of the student model is based on (i) the labeled video data and (ii) the pseudo-labels associated with the unlabeled video data, wherein the student model utilizes student weights initialized based on the pre-trained weights, wherein iterations of the training of the student model updates the student weights.

20. The method of claim 19, wherein each of the labeled video data and the unlabeled video data respectively include a key frame and a plurality of reference frames adjacent the key frame, and wherein the method further comprises:
providing weak augmentations to a first group of the key frames and reference frames of the unlabeled video data; and
utilizing the weak augmentations during the training of the teacher model to generate the pseudo-labels.
